(19) United States
(12) Patent Application Publication
(10) Pub. No.: US 2013/0306167 A1
(43) Pub. Date: Nov. 21, 2013

(54) Airflow check valve

(71) Applicants: David E. Sisk, Bonne Terre, MO (US); Peter J. Kemp, St. Louis, MO (US); Brent D. Kemp, Festus, MO (US); Jason M. Huskey, Bonne Terre, MO (US)

(72) Inventors: David E. Sisk, Bonne Terre, MO (US); Peter J. Kemp, St. Louis, MO (US); Brent D. Kemp, Festus, MO (US); Jason M. Huskey, Bonne Terre, MO (US)

(21) Appl. No.: 13/986,477

(22) Filed: May 7, 2013

Related U.S. Application Data
(60) Provisional application No. 61/688,670, filed on May 18, 2012.

(51) Int. Cl. F16K 15/02; F16L 15/02

(52) U.S. Cl. CPC F16K 15/026
USPC 137/540.11

(57) ABSTRACT

A check valve for use in an air flow line to convey pressurized air to unload a tank trailer, railroad car, or other conveying facility. It includes a housing, having a valve seat, a check valve for seating upon the valve seat, a bushing holding the valve stem for the check valve, with the bushing having a channel therein, through which the valve stem locates, and contains a spring therein that is totally encapsulated within the bushing chamber, during usage. The housing is internally contoured to enhance the flow of pressurized air therethrough.

### CROSS REFERENCE TO RELATED APPLICATION

This non-provisional patent application claims priority to the provisional patent application having Ser. No. 61/688,670, filed on May 18, 2012.

### FIELD OF THE INVENTION

This invention relates to a check valve, and more specifically a check valve for use in an airflow line that facilitates the unloading of granular and related bulk material from tank trailers, railroad cars, and other conveying facilities, and particularly a check valve where its biasing spring is totally encapsulated so that when the spring deteriorates and breaks due to fatigue, the parts of the spring are enclosed within the housing and do not enter into the flow of air, or the granular material, to cause any contamination. Also with a cone shaped poppet helps facilitate the air flow thru the valve without causing turbulence and generating heat as previous design flat poppets in swing gate check valves in the industry do.

### BACKGROUND OF THE INVENTION

Generally, means for conveying of dry bulk material, within systems, has long been used in the art. Pressurized air, translated into air flow, is used to aid in the transfer of the granular material particularly as it is being unloaded from a tank trailer, or other means of conveyance. Within such systems, check valves have been used within the airlines to form the air source control means that allows the pressurized air to flow in one direction, towards the bulk material, to aid in its conveyance. But, the check valves also have a primary usage of attaining closure, as the flow of air ceases, and thereby prevent the granular material from back flowing through the air line, and to cause contamination and blockage within the system, after usage. In any event, the check valve is used to prevent the dry bulk material from running backwards and getting into the air source and blocking up or ruining the blower or compressor which is used to pressurize the air, and to furnish the flowing air source to unload the materials. When there is a back flow of the dry bulk material, it can plug up the total unloading system.

In the past, there have been some developments in the types of check valves used under these circumstances, such as a swing gate or flapper type valve was predominantly used in the system, as a means to control the flow of air, and to prevent back sourcing of the bulk material, particularly towards the source of its unloading air. In a flapper type check valve or flat poppets, this back flowing of bulk material can occur.

There have been check valves that have used for this purpose, but as with the swing gate or flapper type of check valve, their biasing springs, usually of a torsion type, generally were exposed to the passing air, which means that when the check valve or flapper valve breaks, and more particularly its spring fractures, parts of the broken spring are conveyed along with the air source, or flowing pressurized air, becomes entrained within the granular bulk material being conveyed, and thereby can contaminate the entire load which prevents it from being used. This day and age, with product liability suits predominating, having someone chew a piece of spring within a cereal, or other related product, or having a piece of spring embedded with a molded plastic part, could lead towards costly injury, damage, and litigation.

It is as result of these types of detriments that can occur through the use of the prior art of valves, the current invention has been designed to obviate can minimize the chances of occurrence of these predicaments.

### SUMMARY OF THE INVENTION

This invention is generally a horizontal style of check valve, but it can be used in vertical positions also, that applies a coil spring instead of a torsion spring, or other types of exposed springs as were used with the swing gate type of check valve, or even a check valve that has its spring readily exposed to the down stream side of the valve, so that the biasing spring of this improved check valve provides a coil spring that is totally encapsulated within its valve structure, so that if it would break, it is contained entirely within the pocket that houses the spring for the check valve, and it cannot send its broken pieces down the air stream and contaminate the material being pneumatically conveyed. In addition, the structure of this current valve is that it is made of a lesser number of parts, many of its parts are integrated together, which means there are relatively few moving parts for the check valve, other than the valve itself, while the biasing spring part of the check valve and its poppet, as stated, are generally encapsulated within the structure of the spring housing that holds the poppet valve, and is not exposed directly to the passing pressurized air.

Furthermore, the guide bushing used in the check valve of this current invention, is located on the down stream side of the flow chamber, and therefore, reduces the amount of restriction to the flow of the passing pressurized air, during its conveyance through to the unloading system. Thus, as compared to the prior art devices, there is much more open area to the check valve of this invention, providing less restrictive areas for the air to flow, thus providing no impediment against air flow, through the valve, during operations of the air conveying system. This is generally achieved through the use of a bell housing design that enlarges the air flow path.

Hence, the structure of the check valve of this invention incorporates a housing, that is streamlined in its design, that allows a greater area surrounding the check valve for the flow of air to pass therethrough, when the pressurized air opens up the valve, and enhances the air flow, rather than acting as a restrictor, as was provided with and encountered when using the prior art type of swing gate valves, or related types of check valves.

The concept of this invention is to provide a check valve that is used in an air flow line that allows for the flow of air through the air line, past the check valve, for use for unloading a tank trailer, or the like. It incorporates a housing, the housing incorporates a valve seat, the housing does have a widened contour at the location where the check valve, when opened, provides a greater capacity for the pressurized air to pass thereby, thereby not reducing or restricting the pressure of the flowing air, that will be needed to aid in the conveyance of the bulk granular material, during its unloading. A check valve is provided within a bushing, formed of the housing, and the check valve is normally seated enclosed against the valve seat, as when the system is shut off. But, when pressurized air flows through the air flow line, as generated from a compressor, a pump, or the like, further upstream, the check valve becomes unseated, as a result of the bypassing pressurized air, that allows the air to flow through said air line, past the check valve, and to the location where it aids in the conveyance of the granular material, through the material flow line for unloading.

The check valve has a stem connected to it, and the valve stem is provided for locating within a channel provided within the bushing, and encloses a spring around the valve stem, within the bushing channel, and keeps it encapsulated entirely therein, so that when the spring may fatigue, and break into parts, due to reaching excessive unloading cycles, the broken parts of the spring remain entirely enclosed within the bushing channel, and do not enter into the flow of the passing air, nor can it contaminate the flowing air, or attain access into the flowing granular material, that avoids its contamination.

It is, therefore, the principal object of this invention to provide means for substantially reducing the exposure of parts of a check valve, within an air flow line, so that when fatigue of any moving part occurs, it is totally contained and cannot enter into the flow of air, or the granular material being conveyed thereby.

Still another object of this invention is to provide a housing for a check valve that furnishes wider dimensions and a greater flow path for the flowing pressurized air, so as to substantially reduce the incidence of any pressure drop, for the passing pressurized air, as used for unloading of dry bulk materials.

Another object of this invention is to provide means for mounting of the bushing that holds the poppet within the check valve, comprising at least a pair of ribs that may be contoured so as to reduce any resistance to the flow of air there passed, during its usage within an air flow line of an unloading system.

Still another object of this invention is to provide at least a pair of ribs, for holding a bushing for supporting a poppet within a check valve, where the ribs are designed to induce some degree of spiraling flow to the passing pressurized air, to aid in the movement of the dry bulk granular material through its flow line as induced through the impingement of the pressurized air entering from the connected air line.

These and other objects may become more apparent to those skilled in the art upon review of the summary of the invention as provided herein, and upon undertaking a study of the description of its preferred embodiment, in view of the drawings.

### DESCRIPTION OF THE DRAWINGS

In referring to the drawings,

FIG. 1 provides a side view of the air flow check valve of this invention;

FIG. 2 is a left side view of the check valve of FIG. 1;

FIG. 3 is a vertical sectional view taken through the check valve along line 3-3 of FIG. 2;

FIG. 4 is a similar view to the section of the check valve as shown in FIG. 3, but in this instance its poppet is forced open by the flow of air, to allow the pressurized air to flow therepast during performance of an unloading procedure through use of the system;

FIG. 5 is a sectional view showing the mounting ribs and the bushing for holding the poppet in place, taken along the line 5-5 of FIG. 3;

FIG. 6 provides an enlarged view of the bushing, the stem of the poppet, and the encapsulating of the biasing spring totally within the channel of the bushing, as taken along the line 6 of FIG. 3.

### DESCRIPTION OF THE PREFERRED EMBODIMENT

The concept of this invention is to provide a check valve for use in a pressurized air flow line, that can function to prevent the back flow of granular material being conveyed by the system, when the system flow is curtailed; to provide a check valve that is contoured to provide for both uniform flow of pressurized air therethrough, without any pressure reduction, and to also introduce a spiraling flow to the passing air as it moves through the air flow line and enters into the granular material flow line, to induce flow of the granular material during its unloading.

In view of these features, and improvements to an air line check valve, the concept of this invention is generally shown in FIG. 1, wherein this embodiment for the horizontal air flow check valve 1 is shown secured within the air flow line 2 through an arrangement of a series of fasteners 3 that secure the flanges of the air flow line, as at 4, with the flanges of the check valve, as noted at 5. The air of the air flow line passes generally in the direction of the arrows 6 and on the downstream side, usually the air flow line will connect by means of a tee (not shown) and empty its pressurized flowing air into a bulk material conduit, that unloads its dry granular material through the efforts of the passing air to a location for unloading.

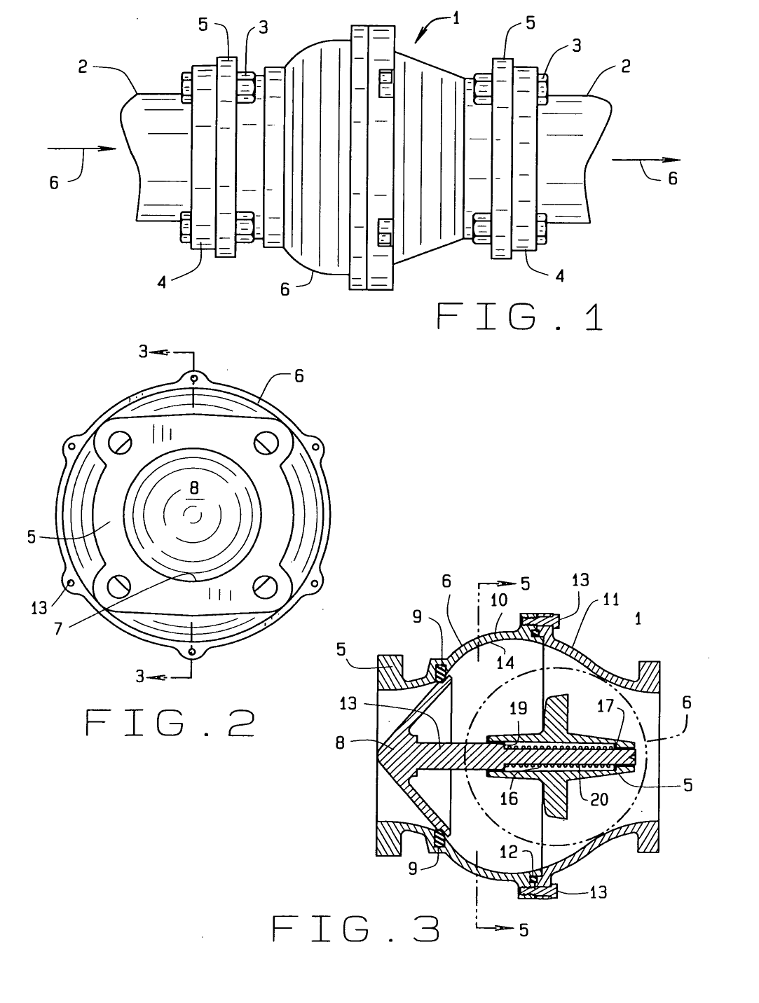

FIG. 2 shows a left end view of the check valve, and its flange 5, as previously described, and is readily disclosed. Furthermore, the housing 6 for the check valve is noted. In addition, the air intake can be seen at 7 and the front of the valve poppet is noted at 8, seated within the housing 6, as understood. A cone shaped poppet is preferred because it facilitates the movement of the pressurized air therepast, during operations of the system.

FIG. 3 provides a vertical section through the center of the check valve 1, and as noted, its poppet 8 is in continuous contact with a valve seat 9 formed of its housing 6. This is a molded gasket seat.

It can also be seen that the housing 6 is formed of two halves, as noted at 10 and 11, and these are fastened into closure, with a sealing O ring 12 provided around its circumference, and secured by means of a plurality of fasteners 13 as to be noted. These two halves form a widened bell housing that accommodates air flow therethrough.

It is to be noted that the housing has an outwardly bulging internal contour 14, forming the bell, so that when the poppet 8 is unseated, there is still ample volumetric capacity for the pressurized air to pass around the poppet, through the housing, an out of the check valve and into the air line 2, so that no pressure reduction of any significance occurs. Hence, generally, the volumetric capacity of the internally convexed housing, as noted at 14, is at least equal to the volumetric capacity of the air flow line 2, so that air under pressure can pass from the air line, into and through the housing 6, and out the air line 2 at the outlet side, without any pressure reduction, or obstruction to the flow of the pressurized air therethrough.

As can also be seen in FIG. 3, there is a bushing 15 that is mounted within the housing, as will be subsequently described, and the bushing 15 as a channel 16 provided therethrough, with a shoulder 17 furnished at its downstream side. The stem 18 of the poppet 8 locates within the channel 16, and the stem includes another shoulder 19 against which a compression spring 20 biases, against both of the shoulders 17 and 19, and generally forces the poppet 8 into closure, against its valve seat 9, in the manner is shown in FIG. 3, so as to constantly bias the poppet into closure within the check valve, when the system is shut off.

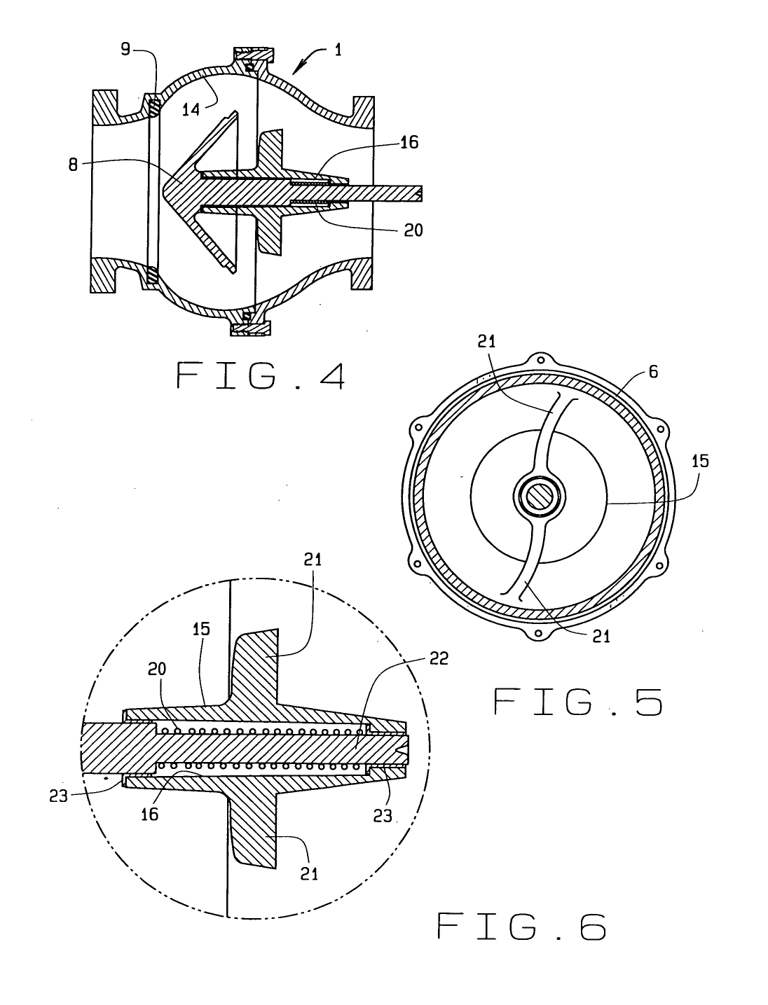

But, as can be seen in FIG. 4, when the poppet 8 is unseated from its valve seat 9, as when air under pressure is forced through the check valve 1, there is yet that ample area surrounding the poppet, as previously explained, along the internal contour 14 of the housing, to allow for the air under pressure to pass there around, without any significant pressure drop.

What is significant about this invention, is that the biasing spring 20 is always arranged between the shoulders 17 and 19 of their respective bushing and valve stem, and that spring remains totally enclosed and encapsulated within the channel 16, of the valve, so that when the spring fatigues, and breaks because of excessive usage, or long term usage, the broken parts of the spring remain within the channel 20, and cannot be discharged there from, to become entrained within the flow of the passing air, or eventually get into the granular material being conveyed, in the bulk material flow line.

FIG. 5 shows how the bushing 15 is structurally supported within the valve housing 6, through the use of at least a pair of integral ribs 21 as to be noted. The ribs have a slight arcuate contour to them, so that as air passes by these mounting ribs, the ribs have a tendency to force the air into a slightly swirling pattern, which helps facilitate the movement of the air, and the forceful conveyance of any granular material, downstream, to enter into and be conveyed to the location of unloading. In addition, these ribs may have a slight contour to them, such as tapering from their upstream to their downstream side, to allow for the air to be separated as it passes the mounting ribs, with little resistance, other than to initiate the air into a more swirling pattern, as it bypasses the mounting ribs and exits from the check valve into the downstream air line 2.

FIG. 6 provides an enlarged view of the bushing 15, part of its ribs 21, and the location of the bushing channel 16, as to be noted. The location of the reduced size of valve stem 22, integral with the valve stem 18 of the poppet, can be seen supporting the compression spring 20 and maintaining the spring located totally within the bushing channel 16, as previously reviewed. Further bearings 23 are provided at each end of the bushing, and embrace the valve stem therein, for sliding movement, as when the poppet moves from its valve seat, as noted in FIG. 3, to its unseated position, as noted in FIG. 4, and thereby prevents any part of a broken spring escaping from the channel 16, in the event that occurs. It can be seen that the extensions upstream and downstream of the bushing 15 support the bearings 23, and regardless whether the valve stem shifts into closure, as in FIG. 3, the channel 16 is always closed off, to prevent discharge of any part of the spring, in the event that it breaks. Likewise, when the spring is subjected to complete compression, as noted in FIG. 4, as when the poppet is forced by the air pressure to unseat from its valve seat 9, the spring still remains closed within the bushing chamber 16, as to be noted. This is due to the integral extension of the bushing 15, that extends integrally upstream, and downstream, from their inherent ribs 21, during manipulation of the check valve between open and closed conditions. It also checks the extent of opening of the valve and its poppet.

It needs to be reviewed that the check valve of this design has performed very satisfactory, and through testing, when compared to flapper valves or check valves of the prior art, this invention performs multiple times better than the prior art valves. For example, when the check valve of this invention was subject to testing, it was tested for 135,000 cycles, without any part of the valve breaking, and with the spring remaining totally sealed within its chamber without any fatigue or fracture. But, when prior art style of valves where tested, one prior art valve, of the flapper type, and which incorporated the tension type of torsion spring, that was exposed to the exterior of the valve, the tested valve failed at 45,000 cycles, and emptied its broken spring parts into the flow of the passing air. Another style of flapper valve, with exposed springs underwent the same testing, failed with broken springs at 46,000 cycles. Thus, it could be seen that the improved check valve of this invention has a functional life cycle almost three times the failure cycle of the prior art style of valves, whether they be of the flapper valve type, or a check valve that has exposed springs. And, the broken spring parts of the prior art valves caused contamination.

It may also be common that during usage it normally takes approximately 15 lbs. of air pressure, or 15 PSI of back pressure, to open these valves, and allow the pressurized air to routinely pass through the check valve, and on to the granular material flow line, to induce and maintain flow of the dry bulk material from their flow line during unloading or conveying to another location for either usage or storage.

In the preferred embodiment of the current invention, usually, when the poppet is open, due to the internal contour of its supportive housing, there is provided approximately a 14.1 square inch minimal flow area around the poppet when it is fully opened, to allow pressurized air to flow therethrough. In addition, there is an approximate 8.6 square inch minimum flow area around the bushing boss, to allow the pressurized air to pass thereby. There is also a minimum 18.1 square inch minimum flow area around the supporting integral fins, for the bushing, to allow air to pass thereby. This type of a check valve normally is used in a 3 inch schedule 10 pipe and in which the check valve of this invention is typically installed and a 3 inch pipe normally provides a flow area of 8.3 square inches, in its dimension.

Variations or modifications to the subject matter of this invention may occur to those skilled in the art upon review of the development as provided herein. Such variations, if within the spirit of this invention, are intended to be encompassed within the scope of any claims to patent protection issuing hereon. The description of the preferred embodiment in this application, and its depiction in the drawings, are primarily set forth for illustrative purposes only.

We claim:

1. A check valve for use in an air flow line applying the flow of air to unload a tank trailer, railroad car, or other conveying facility, comprising:
a housing, said housing incorporating a valve seat, a check valve provided within said housing and normally seated in closure against said valve seat, but when pressurized air flows through an air flow line unseating said check valve to allow air to flow through said line and pass said check valve;
at least one mounting rib provided across said housing, a bushing supported upon said mounting ribs, said bushing having a channel provided therein; and
a valve stem connected to said check valve, said valve stem provided for locating within said bushing channel, a spring provided upon said valve stem and functioning for biasing said check valve into closure, said spring entirely locating within the bushing channel whereby when said spring breaks due to fatigue, the broken spring parts remain sealed within the bushing channel and do not enter into or contaminate the flow of the passing air.

2. The check valve of claim 1 wherein both said bushing and said valve stem incorporate shoulders, said spring biasing against said shoulders, and said shoulders providing closure for the bushing channel to completely contain the biasing spring therein, during its usage and application.

3. The check valve of claim 1 wherein said ribs are integrally formed with the bushing, and said ribs extend to the interior surface of the housing, and integrate therewith, to provide support for the bushing and the check valve during its operations.

4. The check valve of claim 1 wherein said housing has an inlet end, and outlet end, and said housing expanding in diameter between its ends, so as to provide a greater volumetric space for flow of the pressurized air passing therethrough and past the check valve when it is opened during usage.

5. The check valve claim 3 wherein said ribs are of arcuate shape, and thereby provide for initiating the spiraling flow of the air passing through to attain a downstream swirling as the air encounters and urges the flow of granular material during an unloading process.

6. The check valve of claim 4, where in the inlet end of the housing for the check valve incorporates a flange, the outlet end of the housing for the check valve incorporating a second flange, and said flanges provided for securement with the incoming air line, and the outgoing air line, during its installation and usage.

7. The check valve of claim 1, wherein said check valve, when pressurized air is flowing through its housing is below a certain level, providing for closure of the check valve and preventing the backflow of any granular material to prevent clogging of the check valve, and the means providing the generation of the pressurized air, during operations of the air flow means and as it is shutting off.

8. The check valve of claim 1, wherein the said check valve is a poppet valve.

9. The check valve of claim 1, wherein said spring is a helical compression spring.

10. The check valve of claim 1, wherein said bushing includes an integral sleeve that extends towards the check valve, and functions as a stop to limit the extent of opening of the check valve during its operations.

11. The check valve of claim 1, wherein the said housing is separated into two parts, an upstream part and a downstream part, and fasteners provided for securement of the housing into closure, and an O ring provided for surrounding the housing between its parts to provide for sealed closure of the housing during its installation and usage.

12. The check valve of claim 1, wherein said housing has a volumetric flow capacity for passing pressurized air therethrough greater than the volumetric capacity of the incoming and exiting air lines connected with said check valve during its installation and usage.
